(19) United States
(12) Patent Application Publication
(10) Pub. No.: US 2008/0031160 A1
(43) Pub. Date: Feb. 7, 2008

(54) Method for Allocating Paging Cycle in Mobile Communication

(76) Inventors: Gi Seon Ryu, Seoul (KR); Beom Joon Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/572,982

(22) PCT Filed: Jul. 29, 2005
(86) PCT No.: PCT/KR05/02479

§ 371 Date: Jan. 30, 2007

(30) Foreign Application Priority Data
Jul. 30, 2004 (KR) 10-2004-0060446

(51) Int. Cl. H04L 12/16; H04Q 7/20

(52) U.S. Cl. 370/259; 455/458

(57) ABSTRACT

A paging method in a broadcast wireless access system, and more particularly, a method of allocating a paging cycle to a mobile subscriber station in idle mode is disclosed, by which various paging cycles can be allocated to mobile subscriber stations in idle mode. In allocating a paging cycle to a mobile subscriber station in a communication system supporting an idle mode, the present invention includes the steps or receiving a request of a specific paging cycle from the mobile subscriber station, computing a substantial paging cycle to be allocated to the mobile subscriber station using the specific paging cycle requested from the mobile subscriber station and a basic paging cycle used in common in a paging group to which a serving base station of the mobile subscriber station belongs, and allocating the computed paging cycle to the mobile subscriber station.

### TECHNICAL FIELD

The present invention relates to a paging method in a broadcast wireless access system, and more particularly, to a method of allocating a paging cycle to a mobile subscriber station in idle mode. Although the present invention is suitable for a wide scope of applications, it is particularly suitable for allocating various paging cycles to mobile subscriber stations in idle mode.

### BACKGROUND ART

Generally, the broadband wireless access system supports an idle mode to minimize the power consumption of a mobile subscriber station (MSS). During the idle mode, the mobile subscriber station needs not to execute a handoff procedure in moving between base stations belonging to the same paging zone. Hence, the mobile subscriber station needs not to transmit uplink information for the handoff procedure, thereby reducing the corresponding power consumption.

An operation of mobile subscriber station in the idle mode is explained as follows.

First of all, the paging zone is defined as an entire zone that is taken charge of by a plurality of base stations configuring a paging group. Each of the base stations included in the same paging zone has the same paging cycle (Paging_Cycle) and the same paging offset (Paging_Offset).

A mobile subscriber station is allowed to request a base station for a switching to an idle mode, and the base station carries out an action of delivering its paging-group ID, a corresponding paging cycle and a corresponding paging offset to the mobile subscriber station. By such an action, the corresponding mobile subscriber station can enter an idle mode. During the idle mode, the mobile subscriber station is capable of deciding whether to keep or terminate the idle mode via a paging message delivered in a broadcast form from the base station each paging cycle delivered from the base station.

If there occurs a traffic that has to be transmitted by a mobile subscriber station in idle mode, the mobile subscriber station can terminate the idle mode at any time. If there occurs a traffic that has to be transmitted to the mobile subscriber station in idle mode from a base station belonging to a paging zone, the base station is capable of enabling the mobile subscriber station to terminate the idle mode by sending a paging. Moreover, if the mobile subscriber station, which has moved to another paging zone or has lost its sync with the base station belonging to the paging zone, in the idle mode is unable to receive a paging at a predefined duration, the mobile subscriber station terminates the idle mode.

Consequently, the mobile subscriber station having already entered the idle mode normally receives a periodic paging to secure its free move in the same paging zone without performing the handoff procedure as long as receiving or transmitting no traffic.

1) Configuration of Paging Zone

In order to configure one paging zone, a backbone message (Paging-group-action) shown in Table 1 is used. The backbone message is transferred between base stations by wire. The backbone message can be used for the following four usages according to a action code,

TABLE 1

| Field | Size | Notes |
|---|---|---|
| Message Type | 8 bits | |
| Sender BS ID | 48 bits | Base station unique |
| | | identifier (Same |
| | | number as that |
| | | broadcasted on the DL- |
| | | MAP message) |
| Target BS ID | 48 bits | Base station unique |
| | | identifier (Same |
| | | number as that |
| | | broadcasted on the DL- |
| | | MAP message) |
| Time Stamp | 32 bits | Number of milliseconds |
| | | since midnight GMT |
| Action Code | 4 bits | 0 - Assign target BS |
| | | to paging groups |
| | | 1 - Remove target BS |
| | | from paging |
| | | groups |
| | | 2 - Query (which |
| | | paying groups |
| | | target BS belongs |
| | | to?) |
| | | 3 - Information |
| | | (Paging groups |
| | | sender BD belongs |
| | | to) |
| Num Records | 4 bits | Number of paging- |
| | | group-ID records |
| For(j=0; | | |
| j<Num | | |
| Records; j++) | | |
| { | | |
| Paging- | 16 bits | Paging group ID |
| group_ID | | |
| PAGING_CYCLE | 16 bits | Cycle in which the |
| | | paging message is |
| | | transmitted within the |
| | | paging group |
| PAGING OFFSET | 8 bits | PAGING OFFSET |
| | | parameter |
| } | | |
| Security | TBD (to be | A means to |
| field | determined) | authenticate this |
| | | message |
| CRC field | 32 bits | IEEE CRC-32 |

Action = 0: A receiving base station (target BS) can be designated to a specific paging group.
Action = 1: The target BS can be excluded from the specific paging group.
Action = 2: It can be queried which paging group the target BS belongs to.
Action = 3: It can be informed which paging group a transmitting base station (sender BS) belongs to.

Since one base station can belong to at least one or more paging zones, the backbone message can contain information of a plurality of paging groups. And, base stations can be informed of the paging cycle and offset used in each paging zone via the backbone message (Paging-group-action).

Hence, it is possible to dynamically assign the base stations to the paging groups using the backbone message.

2) Entering Idle Mode

First of all, to enter an idle mode, a mobile subscriber station uses a de-registration request message (DREG_REQ) as one of MAC (medium access control) messages. A format of the DREG_REQ message is shown in Table 2.

TABLE 2

| Syntax | Size | Notes |
|---|---|---|
| DREG- | | |
| REQ_Message_Format( ) | | |
| { | | |
| Management Message | 8 bits | |
| Type = 29 | | |
| De-registration- | 8 bits | 0x00: MSS de- |
| Request-Code | | registration |
| | | request from BS and |
| | | network |
| | | 0x01: Request for |
| | | MSS deregistration |
| | | from Serving BS and |
| | | invitation of MSS |
| | | paging availability |
| | | mode |
| | | 0x02-0xFF: reserved |
| Paging Cycle Request | 16 bits | Only valid if De- |
| | | registration- |
| | | Request-Code = 0x01 |
| TLV encoded | Variable | |
| parameters | | |
| } | | |

A mobile subscriber station can request a base station that the mobile subscriber station will enter an idle mode by setting a De-registration Request Code of the DREG_REQ message to ‘0x01’ and then by delivering it to a serving base station. In doing so, it is also possible for the mobile subscriber station to deliver a specific paging cycle to the serving base station.

The serving base station having received the DREG_REQ message can respond to the de-registration request from the mobile subscriber station via a de-registration command (DREG_CMD) message. A format of the DREG_CMD message is shown in Table 3.

TABLE 3

| Syntax | Size | Notes |
|---|---|---|
| DREG-CMD_Message_Format( ) { | | |
| Management Message Type = 29 | 8 bits | |
| Action code | 8 bits | |
| TLV encoded parameters | Variable | |
| } | | |

The serving base station allows the mobile subscriber station to enter the idle mode via an action code of the DREG_CMD message shown in Table 4 (Action Code=0x05), allows the mobile subscriber station to make the request to enter the idle mode after a predetermined duration (Action code=0x06), or allows the mobile subscriber station not to make the request to enter the idle mode until the base station transmits the DREG_CMD message (Action code=0x07).

And, the serving base station can deliver a paging group ID, a paging cycle and a paging offset, which will be used by a corresponding mobile subscriber station during an idle mode, to the mobile subscriber station via TLV (type, length and value).

Details of the action code of the DREG_CMD message are shown in Table 4,

TABLE 4

| Action | |
|---|---|
| Code | Action |
| 0x00 | MSS shall leave the current channel and |
| | attempt to access another channel |
| 0x01 | MSS shall listen to the current channel |
| | but shall not transmit until an RES_CMD |
| | message or DREG_CMD with Action Code is |
| | received. |
| 0x02 | MSS shall listen to the current channel |
| | but only transmit on the Basic, Primary |
| | Management, and Secondary Management |
| | Connections. |
| 0x03 | MSS shall return to normal operations and |
| | may transmit on any of its active |
| | connections. |
| 0x04 | MSS shall terminate current Normal |
| | Operations with the BS: the BS shall |
| | transmit this action code only in response |
| | to any SS DREG_REQ. |
| 0x05 | Require MSS de-registration from Serving |
| | BS and request initiation of MSS idle |
| | mode. |
| 0X06 | The MSS may retransmit the DREG_REQ |
| | message after the time duration (REQ- |
| | duration) given by. |
| 0X07 | The MSS shall not retransmit the DREG_REQ |
| | message and shall wait for the DREG-CMD |
| | message. |
| 0x08-0xFF | Reserved |

The mobile subscriber station having entered the idle mode can receive a paging message (MOB_PAG-ADV) delivered in a broadcast form using a predetermined paging cycle and a predetermined paging offset. And, the paging message (MOB_PAG-ADV) has the format shown in Table 5. The mobile subscriber station can maintain or terminate the idle mode by receiving the paging message (MOB_PAG-ADV).

TABLE 5

| Syntax | Size | Notes |
|---|---|---|
| MOB_PAG- | | |
| ADV_Message_Format( ) { | | |
| Management Message | 8 | |
| Type=?? | bits | |
| Num_Paging Group IDs | 8 | Number of Paging |
| | bits | Group IDs in this |
| | | message |
| For(i=0; | | |
| i<Num_Paging_Group_IDs; | | |
| I++ { | | |
| Paging Group ID | 8 | |
| | bits | |
| } | | |
| For(j=0; j<Num _MACs; | | Number of MSS MAC |
| j++) { | | Addresses in |
| | | message can be |
| | | determined from the |
| | | length of the |
| | | message (found in |
| | | the generic MAC |
| | | header). |
| MSS MAC address hash | 24 | The HASH is |
| | bits | obtained by |
| | | computing a CRC24 |
| | | on the MSS 48-bit |
| | | MAC address. The |
| | | polynomial for the |
| | | calculation is |
| | | 0x864CFB. |
| Action Code | 2 | Paging action |
| | bits | instruction to MSS |
| | | 00 = No Action |
| | | Required |
| | | 01 = Perform |
| | | Ranging to |
| | | establish location |
| | | and acknowledge |
| | | message |
| | | 10 = Enter Network |
| | | 11 = Reserved |
| Reserved | 6 | |
| | bits | |
| } | | |
| } | | |

However, in the above-explained related art method, the biggest problem lies in that the entire mobile subscriber stations belonging to the same paging zone can have one paging cycle only. Hence, even if a mobile subscriber station having a relatively small quantity of power requests a longer paging cycle, it is unreasonable that the mobile subscriber station has no choice but to follow the paging cycle determined in configuring the paging zone. Specifically, a paging cycle request area included in a TLV encoding parameter of each of the conventional DREG_REQ and DREG_CMD becomes meaningless at all.

Since a base station should include the MAC addresses (24 bits) of all mobile subscriber stations in the paging message (MOB_PAG-ADV) delivered in the broadcast form each paging cycle in case that a great deal of the mobile subscriber stations enter the idle mode simultaneously in one paging zone, a length of the paging (MOB_PAG-ADV) considerably increases.

### DISCLOSURE OF THE INVENTION

Accordingly, the present invention is directed to a method of allocating a paging cycle in a mobile communication system that substantially obviates one or more of the problems due to limitations and disadvantages of the related art.

An object of the present invention is to provide a method of allocating a paging cycle in a mobile communication system, by which various paging cycles differing in length can be provided to a plurality of mobile subscriber stations that request to enter an idle mode.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in allocating a paging cycle to a mobile subscriber station in a communication system supporting an idle mode, a paging allocating method according to the present invention includes the steps of receiving a request of a specific paging cycle from the mobile subscriber station, computing a substantial paging cycle to be allocated to the mobile subscriber station using the specific paging cycle requested from the mobile subscriber station and a basic paging cycle used in common in a paging group to which a serving base station of the mobile subscriber station belongs, and allocating the computed paging cycle to the mobile subscriber station.

Preferably, the paging cycle allocating method further includes the step of transmitting a paging message (MOB_PAG-ADV) to the mobile subscriber station each the computed paging cycle.

Preferably, the paging cycle allocating method further includes the step of transmitting information about the paging cycle allocated to the mobile subscriber station to a different base station of the paging group to which the serving base station belongs.

Preferably, the computed paging cycle is computed in a manner of multiplying the basic paging cycle by an integer to be closest to the specific paging cycle.

Preferably, the request receiving step includes the step of receiving a first message requesting to enter the idle mode and including information about the specific paging cycle from the mobile subscriber station. More preferably, the first message includes a de-registration request message (DREG_REQ).

Preferably, the computed paging cycle allocating step includes the step of transmitting a second message commanding to enter the idle mode and including information about the computed paging cycle. More preferably, the second message is a de-registration command message (DREG_CMD).

More preferably, the information about the paging cycle transmitted to the different base station includes information about a multiplier between the paging cycle allocated to the mobile subscriber station and the basic paging cycle. More preferably, the information about the paging cycle transmitted to the different base station is included in a paging announce message (Paging-announce).

To further achieve these and other advantages and in accordance with the purpose of the present invention, in allocating a paging cycle to a mobile subscriber station in a communication system supporting an idle mode, a paging allocating method includes the steps of requesting a specific paging cycle to a serving base station from the mobile subscriber station and having the serving base station allocate a paging cycle closest to the specific paging cycle among paging cycles resulting from multiplying a basic paging cycle used in common in a paging group to which the serving base station belongs by integers, respectively to the mobile subscriber station.

Preferably, the paging cycle allocating method further includes the step of receiving a paging message (MOB_PAG-ADV) from one of base stations belonging to the paging group each the allocated paging cycle.

Preferably, the paging cycle requesting step includes the step of transmitting a first message requesting to enter the idle mode and including information about the specific paging cycle to the serving base station. More preferably, the first message includes a de-registration request message (DREG_REQ).

Preferably, the paging cycle allocated step includes the step of receiving a second message commanding to enter the idle mode and including information about the allocated paging cycle from the serving base station. More preferably, the second message is a de-registration command message (DREG_CMD).

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flowchart of a procedure according to one preferred embodiment of the present invention; and

FIG. 2 is a diagram of an example that a serving base station allocates various paging cycles according to one preferred embodiment of the present invention.

### BEST MODE FOR CARRYING OUT THE INVENTION

Reference will now be made in detail to the preferred embodiments of the present invention, examples of which are illustrated in the accompanying drawings.

First of all, the present invention relates to a method of allocating paging cycles having various lengths to mobile subscriber stations in idle mode, respectively, In particular, the present invention proposes a procedure of negotiation with a base station to enable mobile subscriber stations within the same paging zone to be provided with paging cycles having various lengths according to necessity, respectively instead of being provided with a conventional paging cycle of the same length. For this, the present invention proposes two kinds of paging cycle allocating methods as follows.

In a first method, in case that each mobile subscriber station requests to enter an idle mode, a base station allocates a paging cycle request included in a de-registration request message (DREG_REQ) as it is. Since the first method enables all mobile subscriber stations attempting to enter the idle mode to have different paging cycles, respectively, idle mode actions or each base station may become complicated.

In a second method, a paging cycle requested from each mobile subscriber station is allocated in a manner of multiplying a paging cycle, which is used in common by all base stations currently belonging to a same paging group, by an integer. For convenience of explanation in the following description, the paging cycle used in common by the entire base stations belonging to the same paging group is named a basic paging cycle. Through this, it is possible to allow a paging cycle approximate to a value requested by each mobile subscriber station and the entire base stations within the same paging zone simultaneously transmit paging messages according to one paging cycle only. Hence, the second method is simpler than the first in procedure.

Therefore, the second method, which flexibly allows various paging cycles as well as maintains the related art method that all base stations belonging to the same paging group use the same paging cycle, is explained as follows.

In the de-registration request message (DREG_REQ), which is transmitted from a mobile subscriber station to a serving base station in requesting to enter an idle mode, as shown in Table 2, a paging cycle (Paging Cycle Requested) requested by the mobile subscriber station is included. Yet, since a paging cycle (basic paging cycle) is already determined for base stations belonging to a prescribed paging group via the backbone message shown in Table 1 or the like, it is barely probable that the paging cycle requested by the mobile subscriber station is accepted by the base stations as requested.

Hence, the serving base station sets a value closest to a specific paging cycle requested by the mobile subscriber station in a manner of multiplying its current paging cycle (basic paging cycle) by an integer and then informs the mobile subscriber station of the set value via a de-registration command message (DREG_CMD). In doing so, an offset value decided by the backbone message shown in Table 1 or the like can be used as a paging offset.

It is preferable that values of the paging cycle and offset are determined by a paging controller. The paging controller performs a function of computing the values of the paging cycle and offset. The paging controller is included in a specific base station to perform functions. And, the paging controller can perform functions on a high layer to control the base station. In the embodiment of the present invention, it is assumed that the paging controller is included in the serving base station.

After the de-registration command message has been transmitted, the serving base station notifies the entire base stations belonging to the same paging group of the serving base station that the corresponding mobile subscriber station has entered the idle mode using a paging announce message (Paging-announce).

A preferable configuration of the paging announce message (Paging-announce) is shown in Table 7. And, a conventional paging announce message is shown in Table 6. The paging announce message (Paging-announce) according to one preferred embodiment of the present invention is configured in a manner of adding a paging cycle multiplier to the conventional paging announce message. In this case, the paging cycle multiplier corresponds to the information relating to the paging cycle already determined via the backbone message shown in Table 1, i.e., the basic paging cycle and a multiplier with the paging cycle the serving base station has set up at the mobile subscriber station. Hence, the serving base station notifies the connection information with the mobile subscriber station to the entire base stations of the paging group to which the mobile subscriber station belongs to via the paging announce message (Paging-announce) according to one preferred embodiment of the present invention, whereby each of the base Stations can sends a paging to the mobile subscriber station at the same paging cycle and whereby various paging cycles resulting from multiplying the conventional paging cycle (basic paging cycle) by an integer can be allocated to the mobile subscriber station.

TABLE 6

| Field | Size | Notes |
|---|---|---|
| Message Type | 8 bits | |
| = ? | | |
| Sender BS-ID | 48 bits | Base station unique |
| | | identifier {Same number |
| | | as that broadcasted on |
| | | the DL-MAP message) |
| Target BS-ID | 48 bits | Base station unique |
| | | identifier (Same number |
| | | as that broadcasted on |
| | | the DL-MAP message) |
| Time Stamp | 32 bits | Number of milliseconds |
| | | since midnight GMT |
| Num MSS | 8 bits | Number of MSS to be paged |
| For(j=0: j<Num | | |
| MSS; j++) { | | |
| MMS MAC | 48 bits | |
| address | | |
| PAGING_CYCLE | 16 bits | Cycle in which the paging |
| | | message is transmitted |
| | | within the paging group |
| PAGING OFFSET | 8 bits | PAGING OFFSET parameter |
| } | | |
| Security field | TBD (to be | Message associated with |
| | determined) | authentication |
| CRC field | 32 bits | IEE CRC-32 |

TABLE 7

| Field | Size | Notes |
|---|---|---|
| Message Type = ? | 8 bits | |
| Sender ES-ID | 48 bits | Base station unique |
| | | identifier (Same number |
| | | as that broadcasted on |
| | | the DL-MAP message) |
| Recipient BS-ID | 48 bits | Base station unique |
| | | identifier (Same number |
| | | as that broadcasted on |
| | | the DL-MAP message) |
| Time Stamp | 32 bits | Number of milliseconds |
| | | since midnight GMT |
| Num MSS | 8 bits | Number of MSS paged |
| | | according to action code |
| For(j=0; j<Num | | |
| MSS; j++) } | | |
| MSS MAC address | 48 bits | |
| Paging group ID | 8 bits | Paging group ID to which |
| | | MSS belongs |
| Paging cycle | 4 bits | At which paging cycle |
| multiplication | | used within paging group |
| | | is multiplied for |
| | | specific MSS |
| Paging Cycle | 15 bits | Cycle in which the paging |
| | | message is transmitted |
| | | within the paging group |
| Paging Offset | 8 bits | Paging offset parameter |
| Action Code | 3 bits | 0: Add MSS MAC address to |
| | | a paging list |
| | | 1: Delete MSS MAC address |
| | | from the paging list |
| | | 2: MSS needs to be paged |
| | | to set a location end |
| | | response message. |
| | | 3: MSS is paged to enter |
| | | a network |
| | | 4-7: Reserved |
| Reserved | 1 bit | |
| } | | |
| Security field | TBD (to be | Message associated with |
| | determined | authentication |
| CRC field | 32 bits | IEEE CRC-32 |

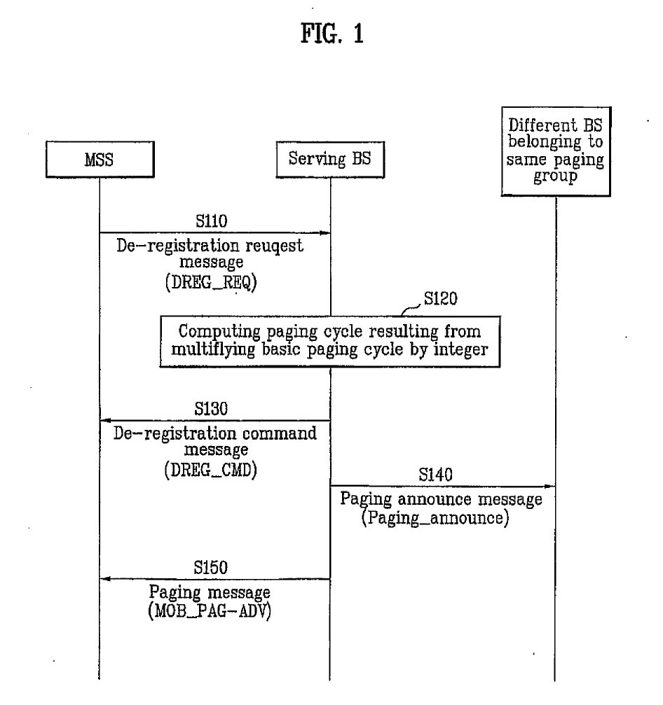

A procedure according to one preferred embodiment of the present invention is explained with reference to FIG. 1 as follows.

FIG. 1 is a flowchart of a procedure according to one preferred embodiment of the present invention.

Referring to FIG. 1, a mobile subscriber station accessible to a wireless communication system supporting an idle mode transmits a de-registration request message (DREG_REQ) to a serving base station to request to enter the idle mode (S110). The serving base station having received the de-registration request message computes a paging cycle closest to a paging cycle requested by the mobile subscriber station via the de-registration request message. Namely, the serving base station computes the paging cycle resulting from multiplying a paging cycle already determined via a backbone message, i.e., a basic paging cycle by an integer (S120). The serving base station includes information associated to the computed paging cycle in a de-registration command message and then transmits the de-registration command message to the mobile subscriber station (S130). And, the serving base station transmits information about the paging cycle multiplier allocated to each mobile subscriber station to other base stations belonging to the same paging group. The information about the paging cycle multiplier allocated to each mobile subscriber station is transmitted to other base stations belonging to the same paging group via a paging announce message (Paging_announce) to notify the paging cycle of each mobile subscriber station to the entire base stations belonging to the same paging group (S140). The serving base station repeatedly transmits a paging message (MOB_PAG-ADV) according to a paging cycle value and a paging offset value allocated to the mobile subscriber station according to one preferred embodiment of the present invention (S150). The paging message is not only transmitted from the serving base station but also transmitted from another base station of the paging group to which the serving base station belongs. The step S140 can be executed prior to the step S130 or after the step S150 and can be repeatedly performed.

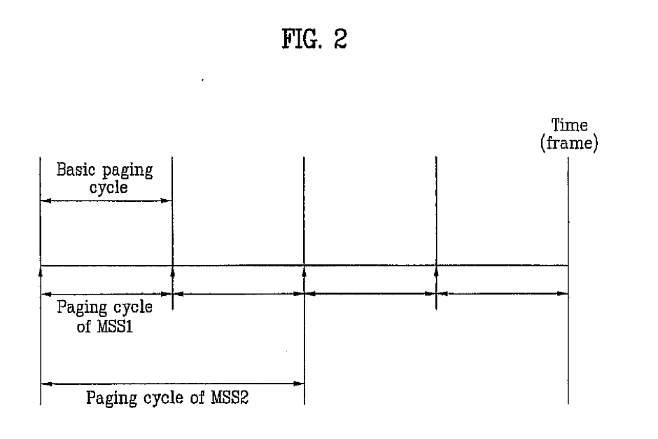

An example that a serving base station allocates various paging cycles according to one preferred embodiment of the present invention is explained with reference to FIG. 2 as follows.

FIG. 2 is a diagram of an example that a serving base station allocates various paging cycles according to one preferred embodiment of the present invention.

Referring to FIG. 2, in case that a paging cycle requested from a first mobile subscriber station MSS1 via a de-registration request message (DREG_REQ) is a value close to a paging cycle (basic paging cycle) determined in a backbone message (Paging-group-action) transmitted between base stations, a multiplier of the first mobile subscriber station MSS1 will correspond to ‘1’. In case that a paging cycle requested from a second mobile subscriber station MSS2 via a de-registration request message (DREG_REQ) is a value close to a value twice greater than the paging cycle (basic paging cycle) determined in a backbone message (Paging-group-action) transmitted between base stations, a multiplier of the second mobile subscriber station (MSS2) will correspond to ‘2’. Namely, the serving base station allocates the same paying cycle of the conventional paging cycle (basic paging cycle) to the first mobile subscriber station MSS1 and allocates the paying cycle twice greater than the conventional paging cycle (basic paging cycle) to the second mobile subscriber station MSS2, The serving base station notifies the paging cycles allocated to the first and second mobile subscriber stations MSS1 and MSS2 via a de-registration command message (DREG_CMD). And, the serving base station delivers the multipliers to the entire base stations belonging to the same paging group via the paging announce message shown in Table 7 so that the entire base stations belonging to the same paging group can allocate various paging cycles according to the present invention.

As mentioned in the foregoing description, the mobile subscriber station in idle mode receives the paging message (MOB_PAG-ADV) delivered in the broadcast form each paging cycle. In case that various paging cycles of the present invention are allocated to a plurality of mobile subscriber stations, respectively, the 24-bit MAC addresses of the entire mobile subscriber stations need not to be included in the paging message (MOB_PAG-ADV) even if the mobile subscriber stations enter the idle mode in one paging zone simultaneously. Hence, the length of the paging message (MOB_PAG-ADV) delivered in the broadcast form is not considerably increased.

In the present invention, through a minimal modification of the action of the idle mode in the broadband wireless access system, it is able to allocate paging cycles having various lengths to mobile subscriber stations requesting to enter the idle mode, respectively. Specifically, instead of ignoring the paging cycle requested from the mobile subscriber station in the related art method, it is advantageous that the present invention enables the negotiation between the mobile subscriber station and the base station. And, the present invention can reduce the power consumption of the mobile subscriber station.

### INDUSTRIAL APPLICABILITY

Accordingly, the present invention is applicable to various communication systems having idle modes. And, the present invention is applicable to various wireless communication systems. Moreover, the present invention is applicable to a broadband wireless access system having an idle mode.

The present invention can allocate paging cycles having various lengths to mobile subscriber stations requesting the idle mode.

And, the present invention takes the paging cycle requested from the mobile subscriber station into consideration to allocate the paging cycle, thereby reducing the power consumption of the mobile subscriber station.

Moreover, the present invention does not transmit the 24-bit MAC addresses of the entire mobile subscriber stations belonging to the paging group each paging cycle, thereby reducing the length of the paging message (MOB_PAG-ADV).

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method of allocating paging cycle in mobile communication system, the method comprising the steps of:
receiving a request of a specific paging cycle from the mobile subscriber station;
computing a substantial paging cycle to be allocated to the mobile subscriber station using the specific paging cycle requested from the mobile subscriber station and a basic paging cycle used in common in a paging group to which a serving base station of the mobile subscriber station belongs; and
allocating the computed paging cycle to the mobile subscriber station.

2. The method of claim 1, further comprising:
transmitting a paging message (MOB_PAG-ADV) to the mobile subscriber station each the computed paging cycle.

3. The method of claim 1, further comprising:
transmitting information about the paging cycle allocated to the mobile subscriber station to a different base station of the paging group to which the serving base station belongs.

4. The method of claim 1, wherein the computed paging cycle is computed in a manner of multiplying the basic paging cycle by an integer to be closest to the specific paging cycle.

5. The method of claim 1, wherein the request receiving step comprising the step of receiving a first message requesting to enter the idle mode and including information about the specific paging cycle from the mobile subscriber station.

6. The method of claim 5, wherein the first message is a de-registration request message (DREG_REQ).

7. The method of claim 1, wherein the computed paging cycle allocating step comprising the step of transmitting a second message commanding to enter the idle mode and including information about the computed paging cycle.

8. The method of claim 7, wherein the second message is a de-registration command message (DREG_CMD).

9. The method of claim 3, wherein the information about the paging cycle transmitted to the different base station includes information about a multiplier between the paging cycle allocated to the mobile subscriber station and the basic paging cycle.

10. The method of claim 3, wherein the information about the paging cycle transmitted to the different base station is included in a paging announce message (Paging-announce).

11. A method of allocating paging cycle in mobile communication system, the method comprising the steps of:
requesting a specific paging cycle to a serving base station; and
receiving information including a paging cycle closest to the specific paging cycle among paging cycles resulting from multiplying a basic paging cycle used in common in a paging group to which the serving base station belongs by integers, respectively to the mobile subscriber station.

12. The method of claim 11, further comprising:
receiving a paging message (MOB_PAG-ADV) from one of base stations belonging to the paging group each the allocated paging cycle.

13. The method of claim 11, wherein the paging cycle requesting step comprising the step of transmitting a first message requesting to enter the idle mode and including information about the specific paging cycle to the serving base station.

14. The method of claim 13, wherein the first message is a de-registration request message (DREG_REQ).

15. The method of claim 11, wherein the information receiving step comprising the step of receiving a second message commanding to enter the idle mode and including information about the allocated paging cycle from the serving base station.

16. The method of claim 15, wherein the second message is a de-registration command message (DREG_CMD).
